(19) United States
(12) Patent Application Publication
(10) Pub. No.: US 2020/0384629 A1
(43) Pub. Date: Dec. 10, 2020

(54) Washing Machine Gasket Cleaner

(71) Applicant: April Jean Wagner, Springfield, MO (US)

(72) Inventor: April Jean Wagner, Springfield, MO (US)

(21) Appl. No.: 16/434,343

(22) Filed: Jun. 7, 2019

(51) Int. Cl. B25G 1/10

(52) U.S. Cl. CPC B25G 1/10

(57) ABSTRACT

The present invention assists in the cleaning of debris and dirt from the rubber gasket seal of the washing machine. The invention is uniquely designed to be inserted into the opening of the rubber gasket seal of the washing machine and be maneuvered around the seal for cleaning maintenance. The tool is made of an elongated handle that is tapered into the head which houses the oval window for a cleaning towelette to be inserted through. The Washing Machine Gasket Cleaner allows for a cleaning towelette to be slide through a window located within the head of the device. The Washing Machine Gasket Cleaner can then be used to clean the rubber sealing gasket of a washing machine. The illustration of the tool and the application of the Washing Machine Gasket Cleaner are depicted in the FIGS. 1-5.

The Washing Machine Gasket Cleaner is a hand held tool or mechanism used to clean the sealing rubber gasket inside a washing machine. The Washing Machine Gasket Cleaner will be made from plastic. The Washing Machine Gasket Cleaner is made of three components: the handle, the head, the towelette window.

The handle is used for the operator to hold onto the tool. The head houses the opening for a cleaning towelette to be utilized while cleaning the sealing rubber gasket of a washing machine tub. The window in the head allows for a cleaning towelette to be slide through the middle of the head without needing other attachments to hold the towelette in place while maneuvering the Washing Machine Gasket Cleaner around the sealing rubber gasket of a washing machine tub.

### BACKGROUND

After many uses of a washing machine, the rubber sealing gasket fills with debris and dirt. The Washing Machine Gasket Cleaner with a towelette inserted through the oval window in the head of the device can be used to maintain the rubber sealing gasket of washing machine. Therefore, aiding in collecting debris and removing built up dirt as well as helping to eliminate odors, the Washing Machine Gasket Cleaner helps maintain the rubber sealing gasket of the Washing Machine Appliance.

### BRIEF DESCRIPTION OF DRAWINGS

FIG. 1 illustrates side view of the Washing Machine Gasket Cleaner.

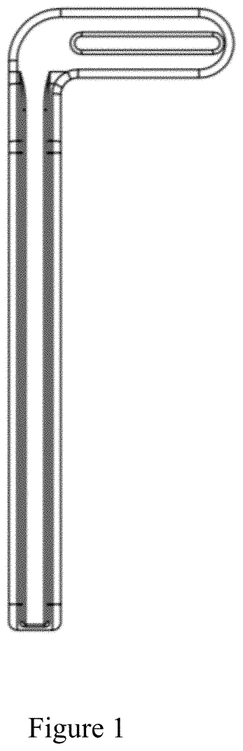

FIG. 2 illustrates the opposing side view of the cleaning device shown in FIG. 1. FIG. 2 indicates the components of the Washing Machine Gasket Cleaner. The handle is labeled 1. The head is labeled 2. The window for cleaning towelette to be inserted through in the head of the tool is labeled 3.

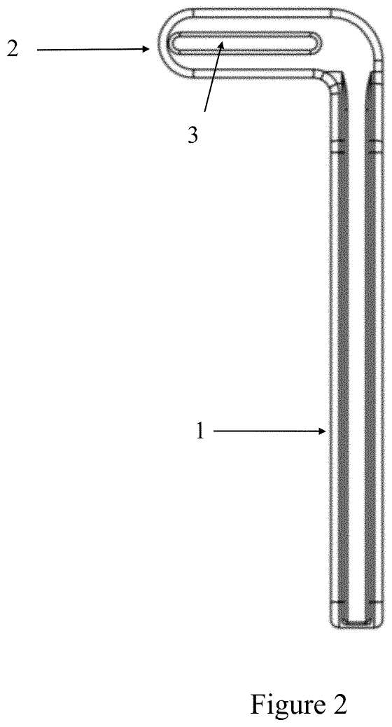

FIG. 3 shows a sectional view of the cleaning device shown in FIG. 1. The Head is tapered at the top.

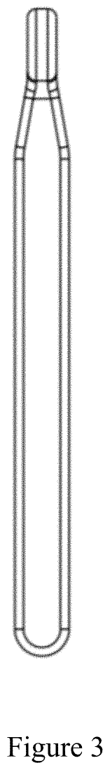

FIG. 4 shows a sectional view of the cleaning device shown in FIG. 1.

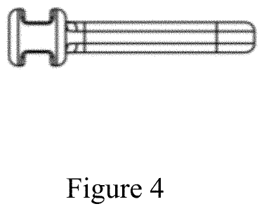

FIG. 5 demonstrates the application of the Washing Machine Gasket Cleaner.

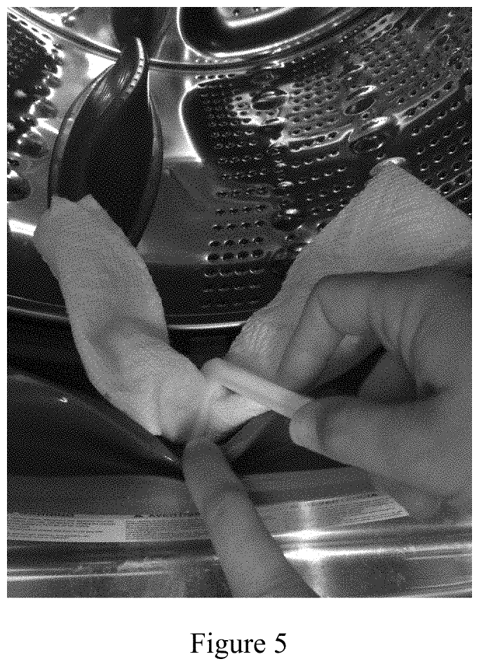

1. The Washing Machine Gasket Cleaner with a towelette inserted through the a window in the head of the device can be used to maintain the rubber sealing gasket of washing machine; aiding in collecting debris and removing built up dirt as well as helping to eliminate odors, the Washing Machine Gasket Cleaner helps maintain the rubber sealing gasket of the Washing Machine Appliance; the Washing Machine Gasket Cleaner is an assistant tool to hold a cleaning towelette which then the head of the tool is inserted into the rubber sealing gasket, rotated around the rubber sealing gasket, and removed out of gasket to assist in cleaning and maintaining the rubber sealing gasket of the washing machine
